(19) United States
(12) Patent Application Publication
(10) Pub. No.: US 2022/0058733 A1
(43) Pub. Date: Feb. 24, 2022

(54) MONITORING, SHARING AND COMBINING CREDIT REPORTS

(71) Applicant: Float Today, Newport Beach, CA (US)

(72) Inventor: Max M.C. Ukropina, Newport Beach, CA (US)

(73) Assignee: Float Today, Newport Beach, CA (US)

(21) Appl. No.: 17/408,393

(22) Filed: Aug. 21, 2021

Related U.S. Application Data
(60) Provisional application No. 63/068,989, filed on Aug. 21, 2020.

(51) Int. Cl. G06Q 40/02; G06Q 50/00; G06Q 50/16; G06F 21/62

(52) U.S. Cl. CPC G06Q 40/025; G06F 21/6245; G06Q 50/16; G06Q 50/01

(57) ABSTRACT

A credit sharing network is provided that allows monitoring a subset of a person's credit report by another person. The credit sharing network allows different subsets of the credit report of a person to be monitored by different persons. The subset of the credit report that is shared with another person may include an indicator such as a color code, an icon, an emoji, a short text, and/or a credit range to indicate the credit worthiness of a person. The credit sharing network may combine the credit reports of two or more persons. Combining the credit report of a group of persons may result in a combined credit score that is higher or lower than the credit report of each individual person in the group. Sharing or combining the credit reports of multiple persons may require authorization from all persons involved.

### CLAIM OF BENEFIT TO PRIOR APPLICATIONS

This application claims the benefit of U.S. Provisional Patent Application Ser. No. 63/068,989, filed on Aug. 21, 2020. The contents of U.S. Provisional Patent Application 63/068,989 are hereby incorporated by reference.

### BACKGROUND

A credit report provides information about a person's credit activities such as loan payment history, the status of the credit accounts, the amount of debt incurred, etc. Creditors, such as lenders, credit card companies, and other financial institutions may report a person's credit information to credit reporting companies.

The credit reporting companies, or credit bureaus, collect and store the credit information and provide credit reports to the lenders and creditors to help them decide whether or not to extend credit to their customers, to determine the amount of credit that may be extended, and/or the interest rate. The credit reports may be used by other entities such landlords who may want to rent or lease residential or commercial properties, utility companies that may want to provide services, employers who may want to make employment decisions, etc.

Credit monitoring is a service that alerts a person whenever a change is made to the person's credit. The person may use the credit monitoring service to confirm the accuracy of any reported activities, detect fraud, evaluate the person's current credit situation, etc. When a person submits a loan or credit application to a financial institution, the financial institution may run a credit check, which may result in adding a hard inquiry listing to the person's credit report.

### BRIEF DESCRIPTION OF THE DRAWINGS

The various embodiments of the present monitoring, sharing, and combining credit reports now will be discussed in detail with an emphasis on highlighting the advantageous features. These embodiments depict the novel and non-obvious monitoring, sharing, and combining credit reports shown in the accompanying drawings, which are for illustrative purposes only. These drawings include the following figures, in which like numerals indicate like parts:

FIGS. 1A-1B illustrate schematic front view of client devices that may include a credit sharing application program which may provide an option for monitoring a subset of the credit report of a person by another person, according to various aspects of the present disclosure;

FIGS. 2A-2B illustrate schematic front view of a client devices that may include a credit sharing application program with a user interface for providing an option for a person to request access for monitoring the credit report of another person, according to various aspects of the present disclosure;

FIGS. 3A-3D illustrate schematic front view of a client devices that may include a credit sharing application program with a user interface for providing an option for increasing the level of access for monitoring the credit report of a person by another person, according to various aspects of the present disclosure;

FIG. 4 illustrates a schematic front view of a client device that may include a credit sharing application program with a user interface for sending encouragement messages from a person to another person, according to various aspects of the present disclosure;

FIG. 5 illustrates a schematic front view of a client device that may include a credit sharing application program with a user interface for allowing a first person to remove the permission of a second person for monitoring the credit of the first person, according to various aspects of the present disclosure;

FIG. 6 illustrates a schematic front view of a client device that may include a credit sharing application program, which may provide an option for a person to stop monitoring the credit of another person, according to various aspects of the present disclosure;

FIG. 7A illustrates an alternative group of indicators that may include emojis and/or color codes for identifying the credit worthiness of a person, according to various aspects of the present disclosure;

FIG. 7B illustrates a schematic front view of a client device that may include a credit sharing application program, which may use the indicators of FIG. 7A to identify the credit worthiness of a person, according to various aspects of the present disclosure;

FIG. 8A illustrates an alternative group of indicators that may include text and/or color codes for identifying the credit worthiness of a person, according to various aspects of the present disclosure;

FIG. 8B illustrates a schematic front view of a client device that may include a credit sharing application program, which may use the indicators of FIG. 7A to identify the credit worthiness of a person, according to various aspects of the present disclosure;

FIG. 9 is a flowchart illustrating an example process for a first person to authorize a second person to monitor a subset of the first person's credit report, according to various aspects of the present disclosure;

FIG. 10 is a flowchart illustrating an example process for a person to request authorization for monitoring a subset of another person's credit report, according to various aspects of the present disclosure;

FIG. 11 is a flowchart illustrating an example process for a person to make changes to the level of monitoring of the person's credit by another person, according to various aspects of the present disclosure;

FIG. 12 is a flowchart illustrating an example process for a person to request an increase in the access level of the person to another person's credit, according to various aspects of the present disclosure;

FIG. 13 is a flowchart illustrating an example process for a person to stop the monitoring of another person's credit or to reduce the level of the monitoring of the other person's credit, according to various aspects of the present disclosure;

FIGS. 14A-14B illustrate schematic front view of client devices that may include a credit sharing application program which may provide an option for combining the credit report information of two more persons, according to various aspects of the present disclosure;

FIGS. 15A-15B are a flowchart illustrating an example process for combining the credit reports of two or more persons, according to various aspects of the present disclosure;

FIG. 16 is a functional block diagram illustrating an example system for sharing credit information, according to various aspects of the present disclosure; and

FIG. 17 is a functional block diagram illustrating an example electronic system, according to various aspects of the present disclosure.

### DETAILED DESCRIPTION

One aspect of the present embodiments includes the realization that the existing credit reporting technology does not allow monitoring of a subset of a person's credit report by another person. There are credit monitoring services that allow a person to monitor the person's own credit report. If a first person provides the user identification and the password of the first person's credit monitoring account to a second person, the second person will be able to see the full credit report of the first person. The first person does not have any control on what parts of the first person's credit report may or may not be accessible to the second person.

The existing credit reporting platforms also do not combine the credit reports of two or more persons in order to provide the combined credit to third parties. Currently, two or more persons who want to apply to a financial entity for a joint loan or a joint line of credit, have to send their individual credit reports to the financial entity and let the financial entity analyze the credit reports. In addition, there are no credit monitoring platforms that provide financial advice to multiple persons based on their combined credit reports.

The present embodiments, as described in detail below, solve the above-mentioned problems by providing a secured credit sharing network that may allow monitoring a subset of a person's credit report by another person. The credit sharing network, in some embodiments, may allow different subsets of the credit report of a person to be monitored by different persons. The subset of the credit report that is shared with another person may be less than a full credit report. For example, the subset may include an indicator such as, for example, and without limitations, a color code, an icon, an emoji, a short text, and/or a credit range to indicate the credit worthiness of the person. The subset may include additional credit information such as the credit score and/or a group of tradelines. Monitoring the credit report of a person by another person may require authorization from both persons. The communication between the electronic devices that communicate through the secured credit sharing network may be encrypted.

Once the monitoring is started, the person whose credit report is being monitored may change the level of information that is being shared or may stop the monitoring at any time. The person who is monitoring a subset of another person's credit may ask for authorization to access additional credit information. In some embodiments, a person who is monitoring a subset of another person's credit may, at any time, stop the monitoring or may reduce the level of credit information that is being monitored.

Some of the present embodiments may provide a credit sharing network that may combine the credit reports of two or more persons who are registered with the credit sharing network. Combining the credit reports of multiple persons may require authorization from all persons whose credit reports are being combined. Combining the credit report of a group of persons, in some scenarios, may result in a combined credit score that is higher or lower than the credit report of some or all individual persons in the group.

Once the combined credit report is available, the credit sharing network may provide financial advice and/or may suggest financial products to the persons in the group based on the combined report. The persons in the group may request that their combined credit report to be forwarded to one or more financial entities such as, for example, and without limitations, financial institutions, loan brokers, landlords, investors, etc.

The remaining detailed description describes the present embodiments with reference to the drawings. In the drawings, reference numbers label elements of the present embodiments. These reference numbers are reproduced below in connection with the discussion of the corresponding drawing features.

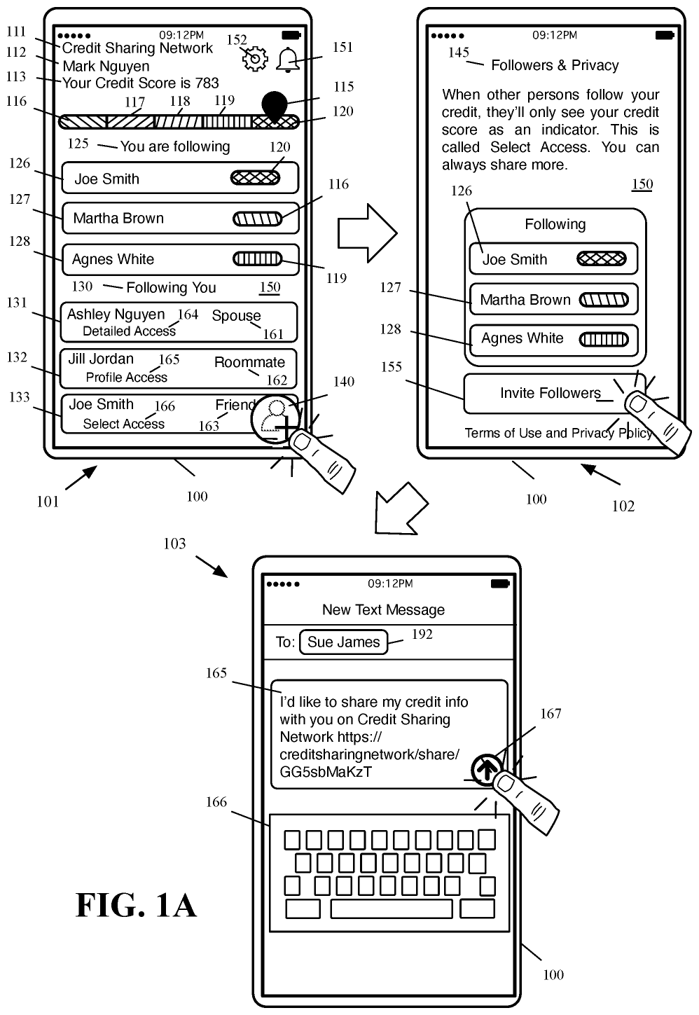

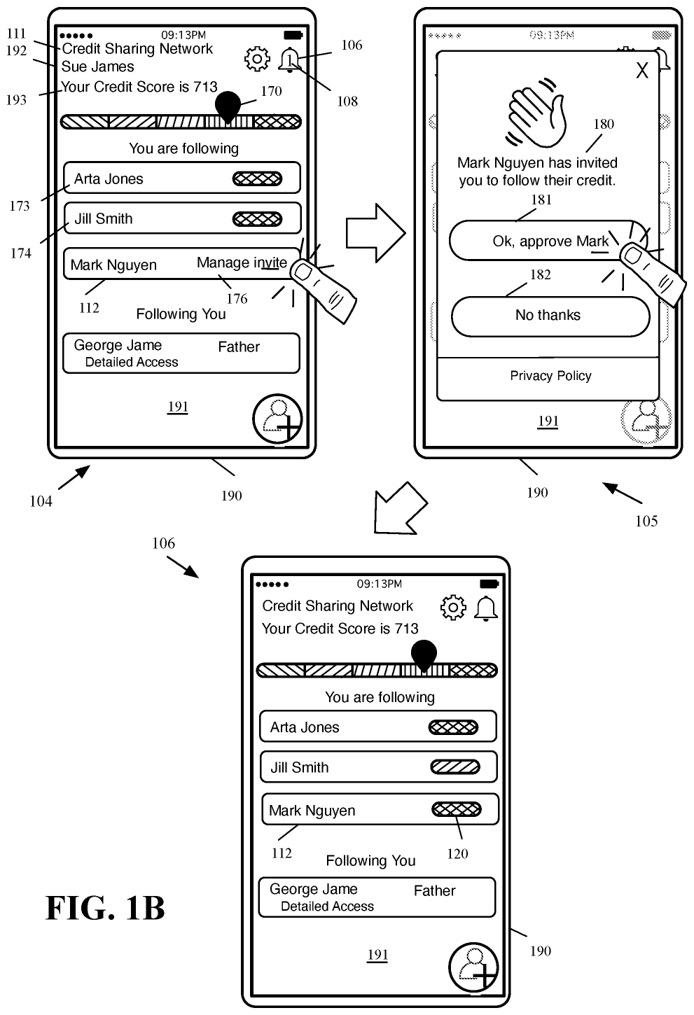

Some of the present embodiments may provide a credit sharing network that may provide tools for sharing the credit reports of the members of the network. FIGS. 1A-1B illustrate schematic front view of client devices that may include a credit sharing application program which may provide an option for monitoring a subset of the credit report of a person by another person, according to various aspects of the present disclosure. The client device 100 may be an electronic device such as, for example and without limitations, a smartphone, a tablet, a desktop computer, a laptop computer, etc.

FIGS. 1A-1B, as shown, include six operational stages 101-106. In stage 101, the client device 100 may have activated a credit sharing application program of a credit sharing network 111. The credit sharing network 111 may register persons such as the person 112. The credit sharing network 111 may retrieve the credit reports of the registered persons from one or more credit reporting bureaus and may store the credit report of each person in a private profile, which is initially accessible only by that person.

The credit sharing application program may display a user interface (UI) 150. The UI 150, in stage 101, may display the name of the credit sharing application network 111 (in this example, the credit sharing application program is called “Credit Sharing Network”), the name of the person 112 whose credit report is displayed by the UI 150, an indicator 151 for alerting the person when an action is pending, and/or a tool 152 for personalizing different features of the credit sharing application program.

The UI 150, in stage 101, may display the credit score 113 of the person 112. The UI 150 may display an indication of the credit worthiness of the person 112. For example, the UI 150 may display a set of indicators 116-120 that may identify different levels of credit worthiness and an indicator (or a pointer) 115 may point the particular indicator (in this example, the indicator 120) that shows the credit worthiness of the person 112.

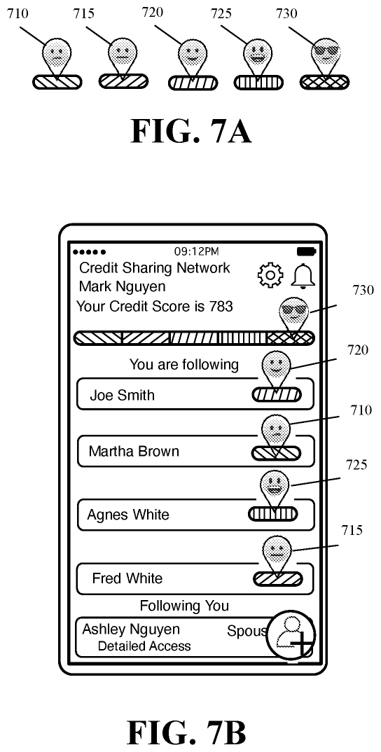

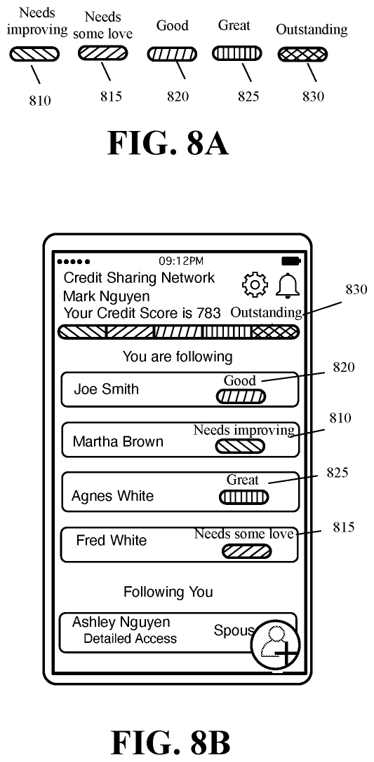

In the example of FIG. 1A, the indicators 116-120 may be different color codes. As described below with reference to FIGS. 7A-8B, the set of indicators may be icons, emojis, short text, score ranges, and/or color codes in different embodiments. Although five indicators 116-120 are shown in the embodiment of FIG. 1A, other embodiments may use fewer or more indicators than five.

With further reference to FIG. 1A, in stage 101, the UI 150 may display a list 125 of the persons whose credit is monitored by the person 112. These persons are referred to as persons who are being followed by the person 112. In this example, the list 125 includes the persons 126-128. The credit worthiness of each person 126-128 may be shown by a corresponding indicator (in this example, the indicators 120, 116, and 119, respectively).

In stage 101, the UI 150 may display a list 130 of the persons 131-133 who are monitoring the credit of the person 112. These persons are referred to as persons who are following the person 112. The UI 150 may display the relationships 161-163 of the persons 131-133 with the person 112. The UI 150 may display the level 164-166 of the credit of the person 112 that is being monitored by each person 131-133. In some embodiments, the UI 150 may be scrollable to display additional persons in the lists 125 and 130. For example, in the embodiments that the client device 100 include a touchscreen, the UI 150 may scroll up or down by a touch gesture. In addition to, or in lieu of, begin scrollable by a touch gesture, the UI 150 may include a set of scrolling tools (not shown) to move the display content up or down.

The UI 150, in stage 101, may provide an edit tool 140 to add persons to monitor the credit report of the person 112 and/or to add persons whose credit is to be followed the person 112. As shown in stage 101, the edit tool 140 may be selected.

In response to the selection of the tool 140, the UI 150, in stage 102, may display the list of the persons 126-128 whose credit report is being monitored by the person 112 and an option 155 to invite followers (e.g., to invite persons to monitor a subset of the credit report of the person 112).

In some embodiments, the credit sharing network 111 may initially provide a minimum subset of a person's credit report to the credit report followers of a person. The credit sharing network 111 may then provide tools for increasing the level of access to the credit report being monitored. As shown by the follower and privacy information 145, when other persons follow a person's credit, the other persons only see the person's credit score as an indicator, which is referred to as “Select Access.” The person may always provide authorization for sharing more.

As shown, the option 155 to invite followers may be selected in stage 102. In response to the selection of the option 155, the UI 150 may send messages to one or more persons to invite them to monitor the credit report of the person 112. Different types of messages may include text messages, emails, and/or messages left for the invited persons in their credit sharing network's profiles. In some embodiments, each person may determine the types of messages the person may receive from the credit sharing network. For example, each person may use the tool 152 to set their specific preferences. In other embodiments, one or more types of messages may be used by default.

As shown in stage 103, the name(s) 192 of one or more persons (in this example the name of one person) may be received (e.g., through a touch keyboard 166 and/or a physical keyboard) and a message 165 may be composed to send to the invited persons to monitor the credit of the person 112. In the example of FIG. 1A the composed text message 165 may be sent to the recipient(s) after the selection of the option 167.

FIG. 1B shows the client device 190 of the person 192 that is invited to monitor the credit of the person 112. As shown in stage 104, the client device 190 may have activated the credit sharing application program of the credit sharing network 111. The credit sharing application program may display the UI 191. The UI 191, in stage 104, may display the name of the credit sharing application network 111, the name of the person 192 whose credit report is displayed by the UI 191, and the credit score 193 of the person 192.

The indicator 106, in stage 104, may be badged with the number 108 of actions that may be pending for the person 192. The UI 191 may display the names of the persons 173-174 whose credit is being monitored by the person 192. The UI 191 may also display the name 112 of the person who has requested an action from the person 192 and an indicator 176 showing that an invitation needs to be managed. As shown, the indicator 176 (or the name 112) may be selected in stage 104.

In response, the UI 191 may display a message 180 in stage 105 indicating that a person has invited the person 192 to follow the credit of the person 192. The UI 191 may display an option 181 to approve the invitation and an option 182 to reject the invitation. As shown, the option 181 may be selected in stage 105 to approve the invitation. In response to the selection of the option 181, the UI 191 in stage 106 may allow the person 192 to monitor the credit of the person 112 and may provide an indicator 120 showing the credit worthiness of the person 112.

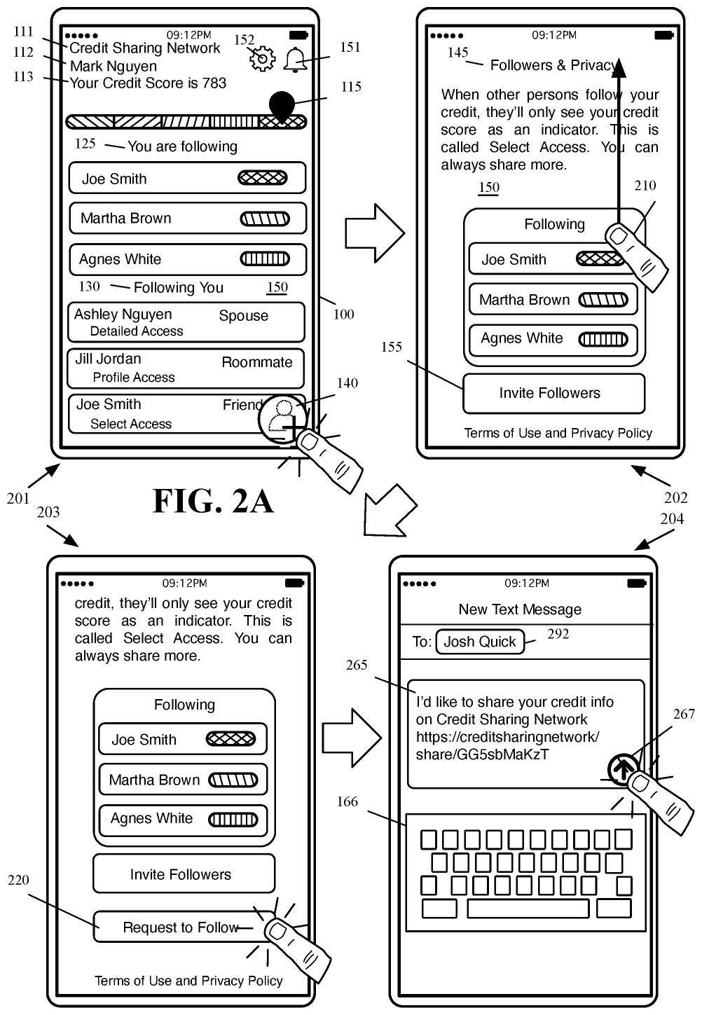

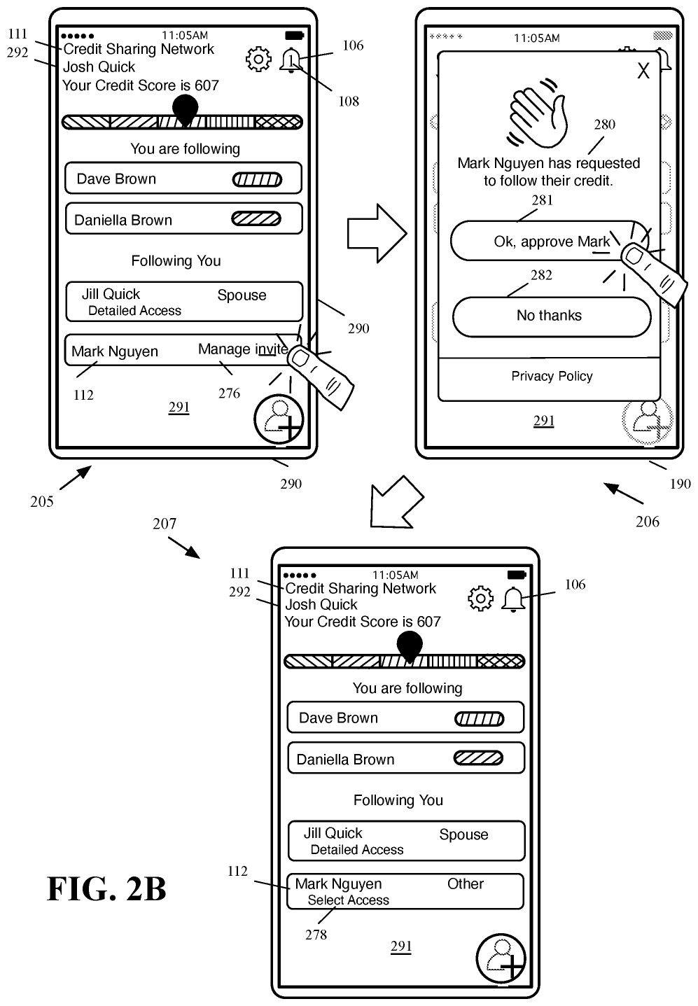

FIGS. 2A-2B illustrate schematic front views of client devices that may include a credit sharing application program with a user interface for providing an option for a person to request access for monitoring the credit report of another person, according to various aspects of the present disclosure. FIGS. 2A-2B, as shown, include seven operational stages 201-207.

Stage 201 is similar to stage 101 of FIG. 1. As shown in stage 201, the edit tool 140 may be selected. In response to the selection of the tool 140, the UI 150 may display the list of the persons whose credit report is being monitored by the person 112 and an option 155 to invite followers. As shown in stage 202, the display screen may be scrolled down to show additional options. In the embodiments that the client device 100 has a touchscreen, the UI 150 may be scrolled (as shown by 210) after receiving a hand gesture. In the embodiments that the client device 100 does not have a touchscreen, the UI 150 may be scrolled by a scrolling tool (not shown).

In stage 203, the UI 150 may provide an option 220 for sending a request to one or more person to follow their credits. As shown, the option 220 may be selected in stage 203. In response to the selection of the option 220, the UI 150 may send messages to one or more persons to request for authorization to monitor their credit report by the person 112. Different types of messages may include text messages, emails, and/or messages left for the invited persons in their credit sharing network's profiles.

As shown in stage 204, the name(s) 292 of one or more persons may be received (e.g., through a touch keyboard 166 and/or a physical keyboard) and a message 265 may be composed to send to the person(s) 292. In the example of FIG. 2A the composed text message 265 may be sent to the recipient(s) after the selection of the option 267.

FIG. 2B shows the client device 290 of the person 292 whose credit is requested to be monitored by the person 112. As shown in stage 205, the client device 290 may have activated the credit sharing application program of the credit sharing network 111. The credit sharing application program may display the UI 291. The UI 291, in stage 205, may display the name of the credit sharing network 111 and the name 292 of the person whose credit report is displayed by the UI 191.

The indicator 106, in stage 205, may be badged with the number 108 of actions that may be pending for the person 292. The UI 291 may display the name(s) of the person(s) 290 who are/is monitoring the credit of the person 292. The UI 291 may also display the name 112 of the person who has requested an action from the person 192 and an indicator 276 showing that an invitation may need to be managed. As shown, the indicator 276 (or the name 112) may be selected in stage 205.

In response, the UI 291 may display a message 280 in stage 206 indicating that the person 112 has requested authorization to follow the credit of the person 292. The UI 291 may display an option 281 to approve the authorization and an option 282 to reject the authorization. As shown, the option 281 may be selected in stage 206 to approve the request. In response to the selection of the option 281, the UI 291 in stage 207 may display the name of the person 112 as a person who is monitoring the credit of the person 292. The UI 291 may also display an indicator 278 identifying the access level that the person 112 has for monitoring the credit of the person 292.

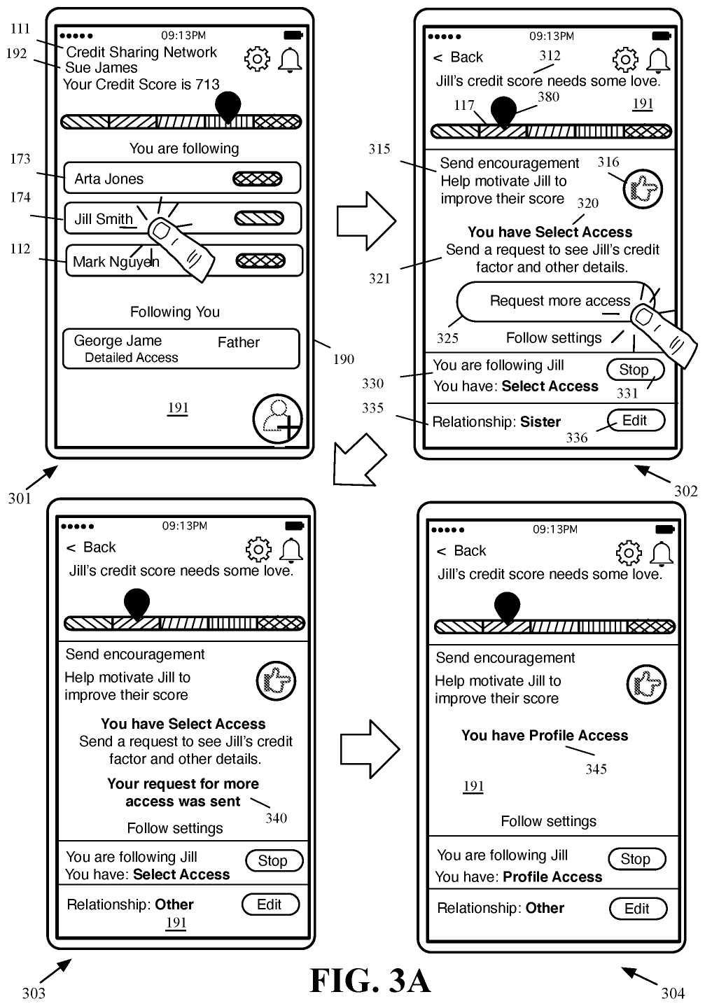

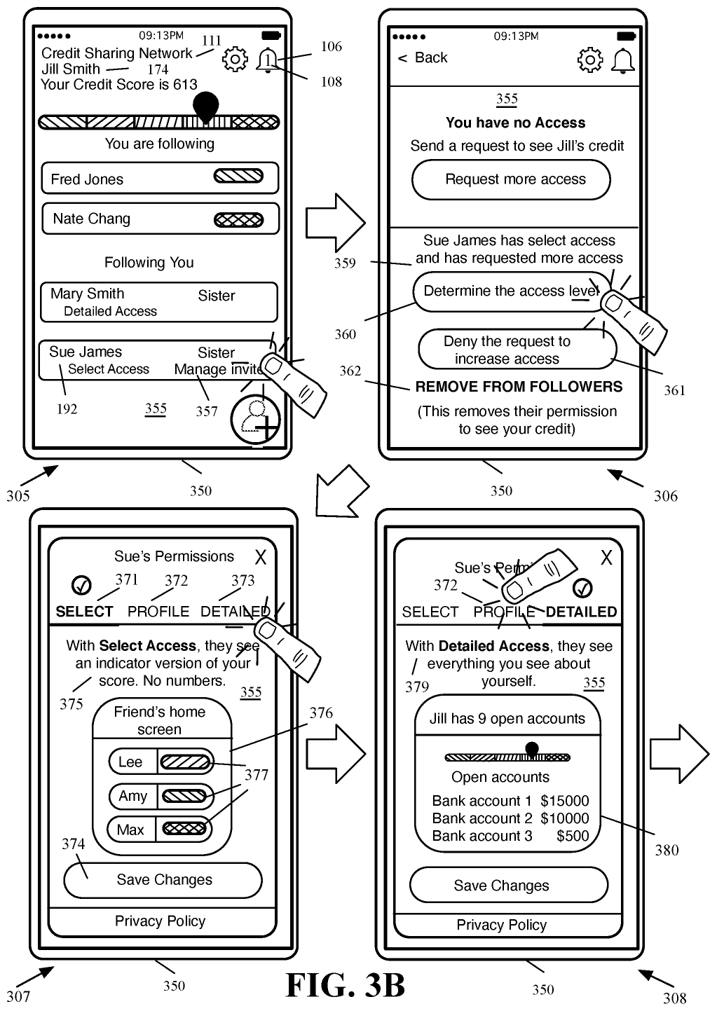

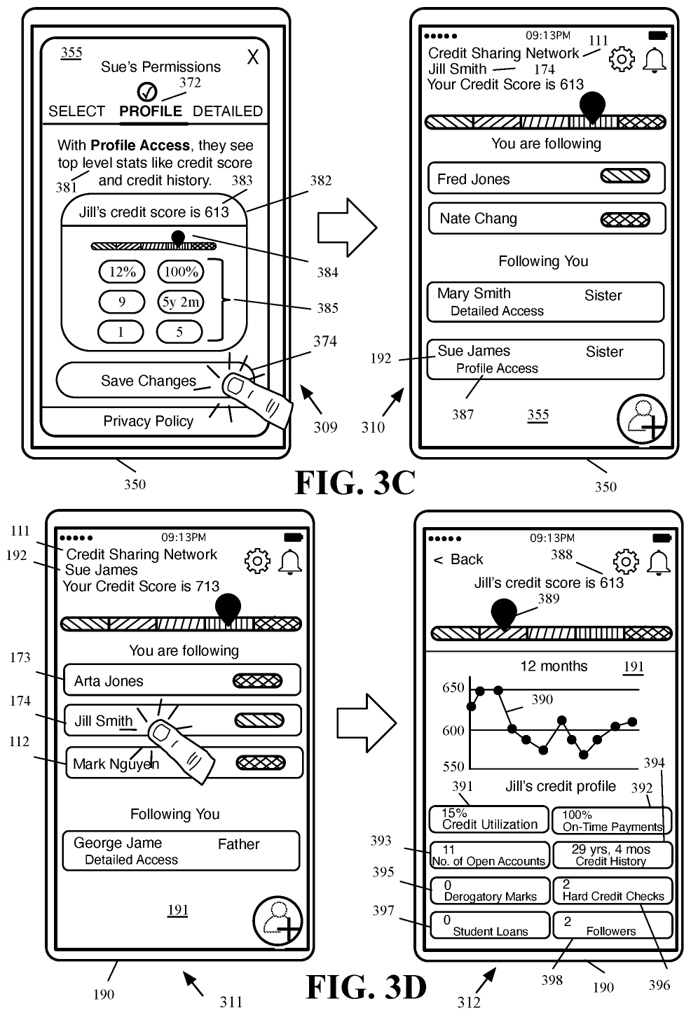

In some embodiments, the initial access level may be less that the full credit report. However, once the credit of a person is being monitored by another person, both persons may be able to make changes to the level of the credit being monitored. FIGS. 3A-3D illustrate schematic front views of client devices that may include a credit sharing application program with a user interface for providing an option for increasing the level of access for monitoring the credit report of a person by another person, according to various aspects of the present disclosure.

FIGS. 3A-3D, as shown, may include twelve stages 301-312. In stage 301, the client device 190 may have activated the credit sharing application program of the credit sharing network 111. The credit sharing application program may display the UI 191. The UI 191, in stage 301, may display the name 192 of the person whose credit report is displayed by the UI 191.

The UI 191, in stage 301, may display the names of the persons 173, 174, and 112 whose credit are being monitored by the person 192. As shown, the name 174 of one of the persons whose credit is being monitored by the person 192 may be selected.

In response, the UI 191, in stage 302, may display further information about the person 174 whose name is selected. As shown, the UI 191 may display a message 312 and/or an indication 117 (as pointed by the pointer 380) regarding the credit worthiness of the person 174. The UI 191 may display a message 315 and an option 316 for sending an encouragement to help motivate the person 174 to improve the person's credit.

The UI 191, in stage 302 may indicate the access level 320 that the person 192 has for monitoring the credit of the person 174. The UI 191 may display a message 321 and an option 325 for requesting more access to the credit of the person 174. The UI 191 may display a message 330 that the person 192 is monitoring the credit of the person 174, an option 331 to stop monitoring the credit of the person 174, the relationship 335 of the persons 192 and 174, and an option 336 to edit the relationship.

As shown, the option 325 may be selected in stage 302. In response, the UI 191, in stage 303 may send a request to the person 174 for more access and may display a message 340 that the request for more access was sent. After the request is accepted by the person 174, the UI 191 may indicate the updated access level 345 in stage 304. In this example, the person 174 has increased the access level of the person 192 from select access (as shown by 320) to profile access (as shown by 345). As described further below with reference to FIG. 3B, the person 174 may have full control on deciding what level of access to give the person 192. Had the person 174 denied the request, the UI 191 may indicate that the request for more access has been denied.

Stage 305 (FIG. 3B) shows the client device 350 of the person 174 after the credit sharing network 111 sends the request for more access for the person 192 to the person 174, as described above with reference to stage 302. As shown in stage 305, the UI 355 may badge the indicator 106 with the number 108 of the pending actions and may indicate that the person 174 has sent an invite to be managed, as shown by 357.

In stage 305, a selection of the option 357 may be received. In response, the UI 355, in stage 306, may display (as shown by 359) the access level of the person 194 to the credit of the person 174. The UI 355 may also display an option 360 for determining the access level of the person 192 to the credit of the person 174. The UI 355 may further display an option 361 for denying the request to increase access and an option 362 for canceling the person 192 access to the credit of the person 174.

In some embodiments, when a second person is requesting additional access to the credit of a person, the credit sharing network 111 may provide the option for the first person to determine the level of access. The first person may keep the access level the same, may increase or decrease the access level, or may cancel the access level.

In response to the section of the option 360, the UI 355, in the stage 307, may provide different options 371-373 for selecting different levels of access for the person 192. Although in the example of FIGS. 3A-3D there are three access levels (namely select 371, profile 372, and detailed 373), other embodiments may provide additional or fewer access levels than three.

As shown in stage 307, the select access 371 is highlighted as the current access level of the person 192 to the credit of the person 174. As indicated by the message 375, the select access may provide an indicator as an indication of the credit worthiness of a person, without providing any numbers. The UI 355 may display an example 376 of what the home screen of the person monitoring the credit of the person 174 may display. In the example of FIG. 3B, the indicators 377 may be color codes indicating the creditworthiness (e.g., a range for the credit score) of the persons whose credits are being monitored.

The UI 355 may provide the option 374 to keep the access level of the person 192 at the select level 371. In this example, however, the option 373 may be selected to change the access level of the person 174 to detailed access 373. In response, the UI 355, in stage 308, may display a message 379 indicating that the person 192 may see everything that the person 174 may see about the credit of the person 174. The UI 355 may display an example 380 of what information the person 192 may see with the detailed access level.

In stage 308, the option 372 may be selected to change the access level of the person 192 to profile access 372. In response, the UI 355, in stage 309 (FIG. 3C), may display a message 381 indicating that the person 192 may see top level statistics, such as the credit score and credit history of the person 174.

The UI 355, in stage 309, may display an example 382 of what information the person 192 may see with the profile access level. For example, the person 192 may see the credit score 383, the credit worthiness indicator 384, and the credit statistics 385 of the person 174. As shown, the option 374 may be selected in stage 309 to increase the access level of the person 192 to the profile access 172. In response, the UI 355, in stage 310, may indicate (as shown by 387) that the access level of the person 192 is changed to profile access.

FIG. 3D illustrates the client device 190 of the person 192 after the access level of the person 190 to the credit of the person 174 is increased to profile access. As shown in stage 311, the name of the person 174 may be selected. In response, in stage 312, the profile level information regarding the credit of the person 174 may be displayed on UI 191 of the client device 190 of the person 192.

As shown in stage 312, the UI 191, may display the credit score 388, the credit worthiness indicator 389, a curve 390 indicating the monthly credit score, and/or a set of statistics 391-398 regarding the credit of the person 174. The statistics may include, for example, and without limitations, the credit utilization 391, the on-time payments 392, the number of open accounts 393, the credit history 394, the number of derogatory marks 395, the number of hard credit checks 396, the number of student loans 397, and the number of the credit followers 398 (i.e., the number of persons who are monitoring the credit of the person 174).

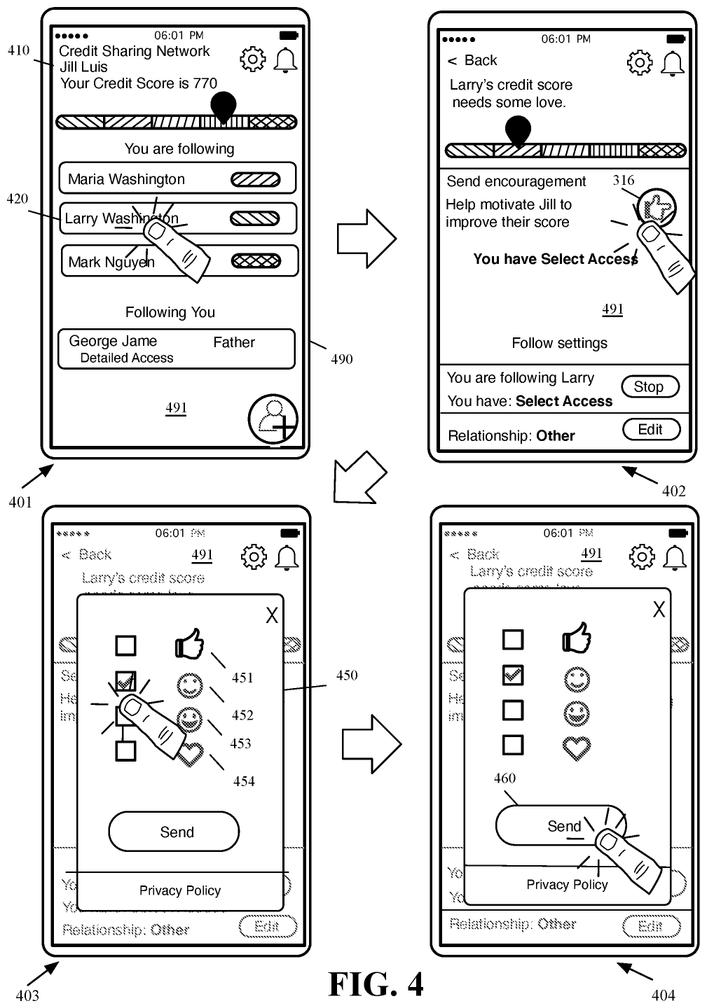

In some embodiments, the credit sharing network may allow a person to send encouragement or kudos to other persons to help motivate each other to improve their score. The encouragement may be, for example, and without limitations, an icon, an emoji, a short text message, etc. FIG. 4 illustrates a schematic front view of a client device 490 that may include a credit sharing application program with a user interface for sending encouragement messages from a person to another person, according to various aspects of the present disclosure.

FIG. 4, as shown, includes four operational stages 401-404. In stage 401, the name 420 of one of the persons whose credit is being monitored by the person 410 may be selected. In response, the UI 491, in stage 402, may display a subset of the credit report of the person 420 that the person 410 is authorized to monitor.

As shown, the option 316 to send encouragement is selected in stage 402. In response, a group of options 451-454 to send encouragement may be displayed. The options 1751-454, in some embodiments, may be displayed in a pop-up window 450. The options 451-454 may be emojis, icons, short messages, etc.

As shown in stage 403, the option 452 may be selected. In stage 404, the option 460 may be selected. In response, a message that include the graphics and/or text associated with the option 452 may be sent from the person 410 to the person 420.

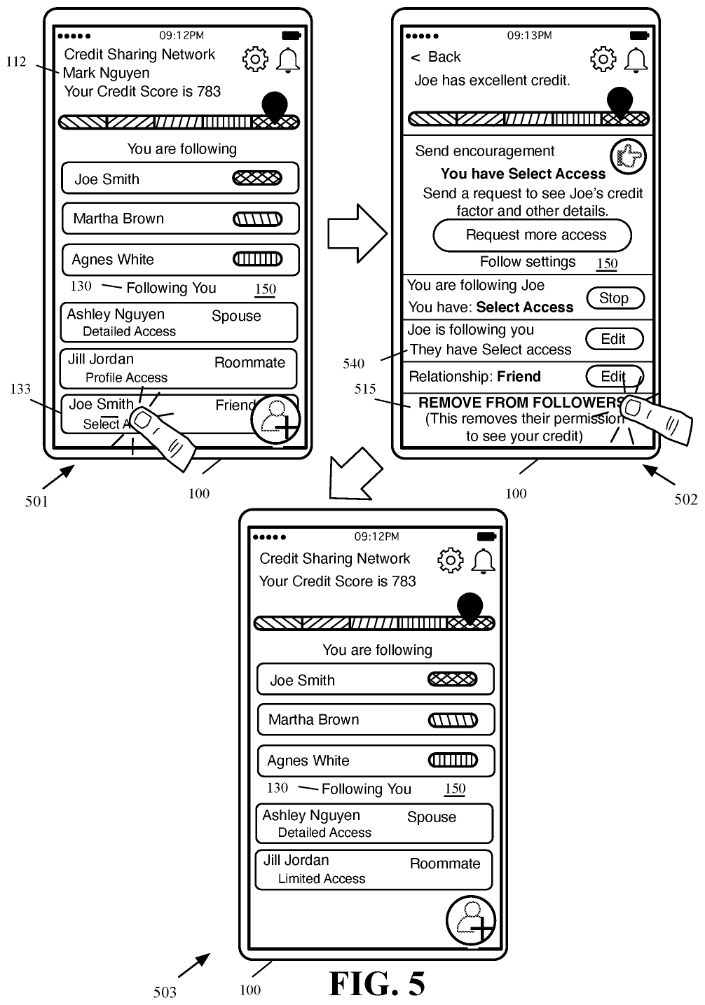

In some embodiments, when the credit of a person is being monitored by another person, each of the two persons may terminate the monitoring at any time. FIG. 5 illustrates a schematic front view of a client device 100 that may include a credit sharing application program with a user interface for allowing a first person to remove the permission of a second person for monitoring the credit of the first person, according to various aspects of the present disclosure.

FIG. 5, as shown, includes three operational stages 501-503. In stage 501, the name 133 of one of the persons who is monitoring the credit of the person 112 may be selected. In response, the UI 150, in stage 502 may display a subset of the credit report of the person 133 that the person 112 is authorized to monitor.

The person 133 may also have permission to monitor the credit of the person 112. In this example, the person 133 has select access to monitor a subset of the credit of the person 112 (as shown by 540). The UI 150 may provide an option 515 to remove the permission of the person 133 to monitor the credit of the person 112.

As shown in stage 502, the option 515 may be selected to remove the permission for the person 133 to monitor the credit of the person 112. In response, in stage 503, the person 133 is removed from the list 130 of the persons that are monitoring the credit of the person 112.

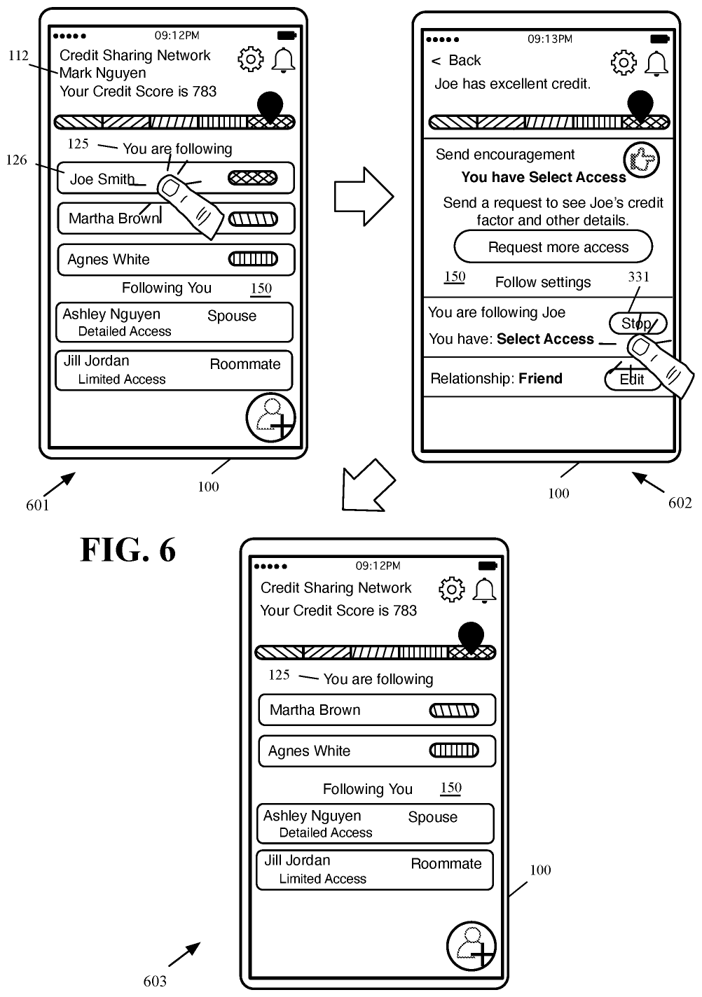

Some embodiments may allow a person who is monitoring the credit of another person to terminate the monitoring at any time. FIG. 6 illustrates a schematic front view of a client device 100 that may include a credit sharing application program with a user interface for allowing a person who is monitoring the credit of another person to terminate the monitoring, according to various aspects of the present disclosure.

FIG. 6, as shown, includes three operational stages 601-603. In stage 601, the name 126 of one of the persons whose credit is being monitored by the person 112 may be selected. In response, the UI 150, in stage 602 may display a subset of the credit report of the person 126 that the person 112 is authorized to monitor.

The UI 150 may provide an option 331 to stop the monitoring of the credit of the person 126 by the person 112. As shown in stage 602, the option 331 may be selected. In response, in stage 603, the person 133 may be removed from the list 125 of the persons whose credits are being monitored by the person 112.

Different embodiments may use different indicators to indicate the credit worthiness of a person. For example, FIGS. 1A-6 use color indicators 116-120 to indicate the credit worthiness of different persons. FIG. 7A illustrates an alternative group of indicators that may include emojis and/or color codes for identifying the credit worthiness of a person, according to various aspects of the present disclosure.

With reference to FIG. 7A, each of the indicators 710-730 may include an emoji and a color code. In some embodiments, the indicators may only include the emojis without the associated color codes. The emojis' appearance may imply different level of a person's credit.

FIG. 7B illustrates a schematic front view of a client device that may include a credit sharing application program, which may use the indicators of FIG. 7A to identify the credit worthiness of a person, according to various aspects of the present disclosure. With reference to FIG. 7B, the indicators 710-730 may indicate a person's credit worthiness.

FIG. 8A illustrates an alternative group of indicators that may include text and/or color codes for identifying the credit worthiness of a person, according to various aspects of the present disclosure. With reference to FIG. 8A, each of the indicators 810-830 may include a text and a color code. In some embodiments, the indicators 810-830 may only include the text without the associated color codes.

FIG. 8B illustrates a schematic front view of a client device that may include a credit sharing application program, which may use the indicators of FIG. 8A to identify the credit worthiness of a person, according to various aspects of the present disclosure. With reference to FIG. 8B, the indicators 810-830 may indicate a person's credit worthiness with one or more words and/or color codes.

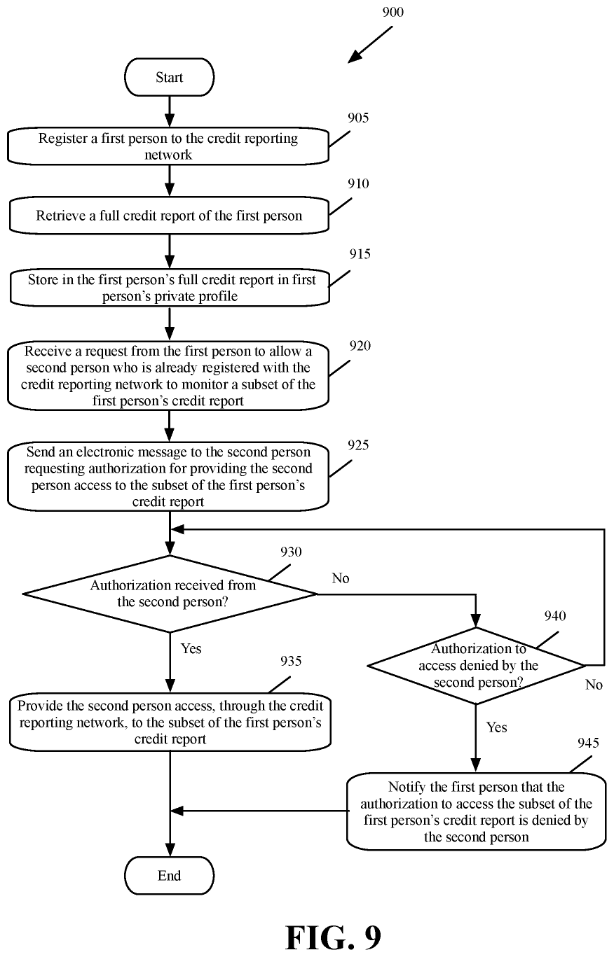

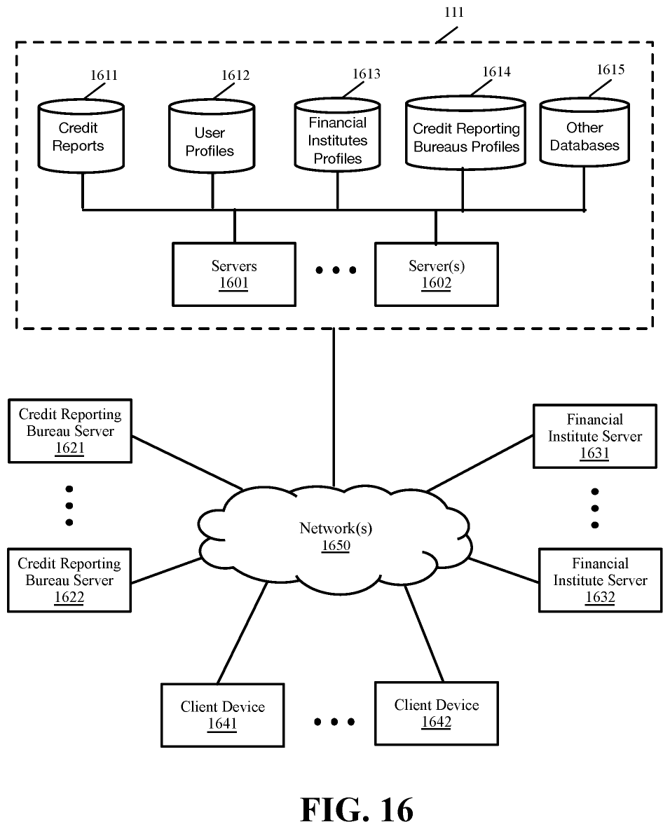

FIG. 9 is a flowchart illustrating an example process 900 for a first person to authorize a second person to monitor a subset of the first person's credit report, according to various aspects of the present disclosure. The process 900, in some of the present embodiments, may be performed by a processing unit of a client device, such as the client devices of FIGS. 1A-6, 7B, 8B, and 16. In other embodiments, the process 900 may be performed by a processing unit of a server 1601-1602 of FIG. 16.

With reference to FIG. 9, the process 900 may register (at block 905) a first person to a credit sharing network. For example, a person 112 may be registered to the credit sharing network 111 of FIG. 1A. Next, a full credit report of the first person may be retrieved (at block 910). For example, the credit sharing network 111 may retrieve the full credit report of the person 112 from one of the credit reporting bureaus. In some embodiments, retrieving the credit report of the person may be done without a hard pull, which may not result in a hard inquiry listing in the person's credit report.

The first person's full credit report may be stored (at block 915) in the first person's private profile. In some embodiments, the credit sharing network may create a private profile for each registered member and may store the full credit report of the person in the person's private profile. The full credit report of a person or any portions thereof may not be shared with any other members of the credit sharing network without the consent of the person.

Next, a request may be received (at block 920) from the first person to allow a second person to monitor a subset of the first person's credit report. For example, the credit sharing network 111 may receive a request from the person 112 to send a request to the person 192 to monitor the credit of the person 112, as described above with reference to stage 103 of FIG. 1A. The subset, in some embodiments, is less than the full credit report of the first person.

An electronic message may be sent (at block 925) to the second person requesting authorization for providing the second person access to the subset of the first person's credit report. For example, the credit sharing network 111 may send an electronic message to the person 192 requesting authorization for providing the person 192 access to the subset of the credit report of the person 112, as described above with reference to stages 103-105 of FIGS. 1A-1B.

Next, a determination may be made (at block 930) whether the authorization is received from the second person. When authorization is received (at block 930) from the second person, the second person may be provided (at block 935) access, through the credit reporting network, to the subset of the first person's credit report. For example, the person 192 may be provided access to a subset of the person 112, as described above with reference to stage 106 of FIG. 1B. The process 900 may then end.

When authorization is not received (at block 930) from the second person, a determination may be made (at block 940) whether access is denied by the second person. For example, a determination may be made whether the person 192 has selected the option 182 as described above with reference to stage 105 of FIG. 1B. When access is not denied (at block 940) by the second person, the processing may proceed to block 930, which was described above. Otherwise, the first person may be notified (at block 945) that the authorization to access the subset of the first person's credit report is denied by the second person. The process 900 may then end.

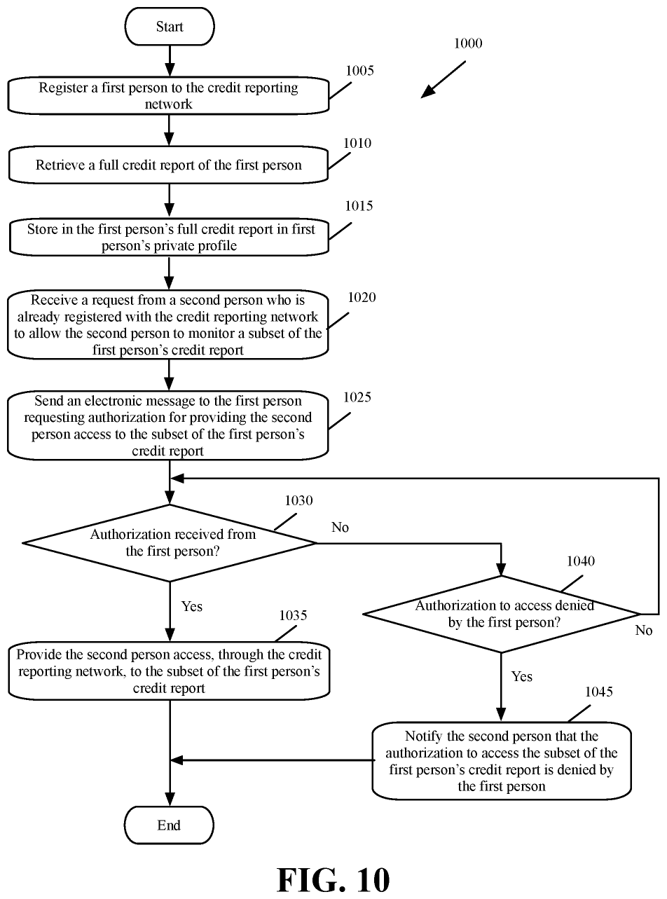

Some embodiments may allow a person to request authorization to share a subset of another person's credit and may provide access to the requesting person once the person whose credit is to be shared approves the request. FIG. 10 is a flowchart illustrating an example process 1000 for a person to request authorization for monitoring a subset of another person's credit report, according to various aspects of the present disclosure.

The process 1000, in some of the present embodiments, may be performed by a processing unit of a client device, such as the client devices of FIGS. 1A-6, 7B, 8B, and 16. In other embodiments, the process 1000 may be performed by a processing unit of a server 1601-1602 of FIG. 16.

With reference to FIG. 10, blocks 1005-1015 are similar to the corresponding blocks 905-915 of FIG. 9. At block 1020, a request may be received from the second person who is already registered with the credit reporting network to allow the second person to monitor a subset of the first person's credit report. For example, the credit sharing network 111 may receive a request from the person 112 to send an authorization request to the person 292 to monitor the credit of the person 292, as described above with reference to stage 204 of FIG. 2A. The subset of the first person's credit report may be less than the first person's full credit report, for example, as described above with reference to FIGS. 3B-3D.

With continued reference to FIG. 10, an electronic message may be sent (at block 1025) to the first person requesting authorization for providing the second person access to the subset of the first person's credit report. For example, the credit sharing network 111 may send an electronic message to the person 292 requesting authorization for providing the person 112 access to the subset of the credit report of the person 292, as described above with reference to stages 204-206 of FIGS. 2A-2B.

Next, a determination may be made (at block 1030) whether the authorization is received from the first person. When the authorization is received (at block 1030) from the first person, the second person may be provided (at block 1035) access, through the credit reporting network, to the subset of the first person's credit report. For example, the person 112 may be provided access to a subset of the person 292, as described above with reference to stage 207 of FIG. 2B. The process 1000 may then end.

When authorization is not received (at block 1030) from the first person, a determination may be made (at block 1040) whether access is denied by the first person. For example, a determination may be made whether the person 292 has selected the option 282 as described above with reference to stage 206 of FIG. 2B. When access is not denied (at block 1040) by the first person, the processing may proceed to block 1030, which was described above. Otherwise, the second person may be notified (at block 1045) that the authorization to access the subset of the first person's credit report is denied by the first person. The process 1000 may then end.

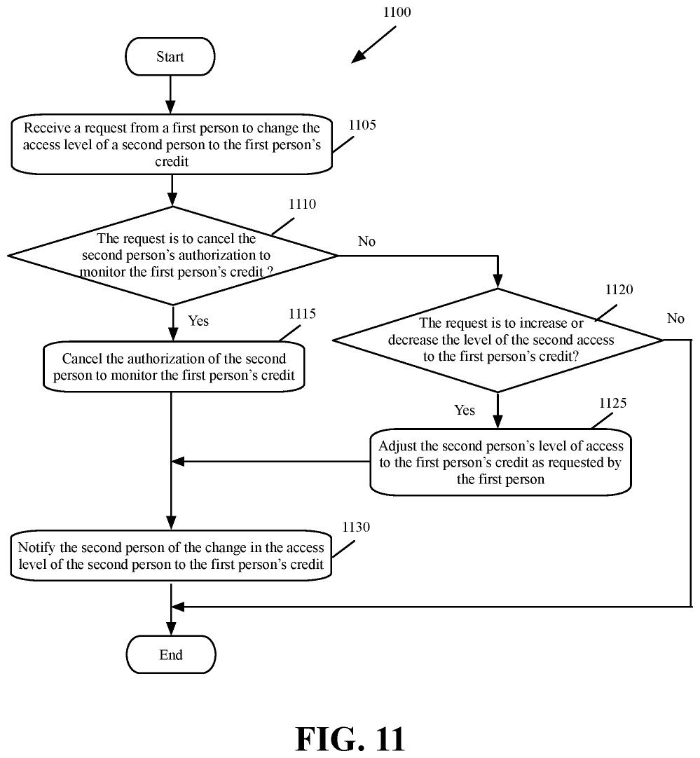

In some of the present embodiments, when the credit of a first person is being monitored by a second person, the first person, at any time, may remove the second person's monitoring authorization or may make a change in the level of the first person's credit that is being monitored by the second person. FIG. 11 is a flowchart illustrating an example process 1100 for a person to make changes to the level of monitoring of the person's credit by another person, according to various aspects of the present disclosure.

The process 1100, in some of the present embodiments, may be performed by a processing unit of a client device, such as the client devices of FIGS. 1A-6, 7B, 8B, and 16. In other embodiments, the process 1100 may be performed by a processing unit of a server 1601-1602 of FIG. 16.

With reference to FIG. 11, a request may be received (at block 1105) from a first person to change the access level of a second person to the first person's credit. For example, the credit sharing network 111 may receive a request from the person 112 to make a change (e.g., to cancel) the monitoring of the credit of the person's 112 by the person 133, as described above with reference to stage 502 of FIG. 5.

A determination may be made (at block 1110) whether the request is to cancel the second person's authorization to monitor the first person's credit. When the request is to cancel the second person's authorization to monitor the first person's credit, the authorization of the second person to monitor the first person's credit may be canceled (at block 1115). For example, the authorization of the person 133 may be canceled for monitoring the credit of the person 112, as described above with reference to stages 502-503 of FIG. 5. The process 1100 may then proceed to block 1130, which is described below.

When the request is not to cancel the second person's authorization to monitor the first person's credit, a determination may be made (at block 1120) whether the request is to increase or decrease the level of the second person's access to the first person's credit. If not, the process 1100 may end.

Otherwise, the second person's level of access to the first person's credit may be adjusted (at block 1125) as requested by the person 192 to the credit of the person 174 may be changed, as described above with reference to stages 307-311 of FIGS. 3A-3D. The second person may be notified (at block 1130) of the change in the access level of the second person to the first person's credit. The process 1100 may then end.

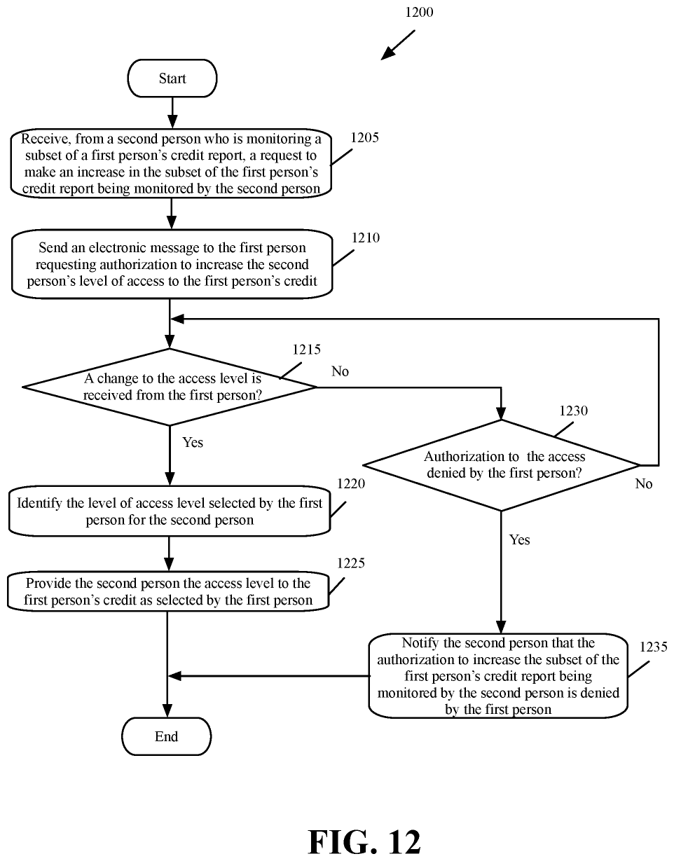

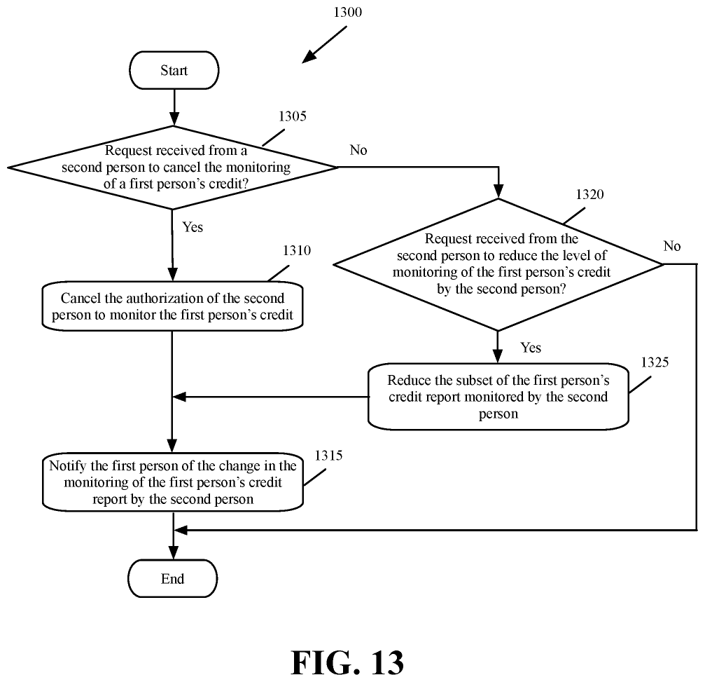

In some of the present embodiments, when the credit of a first person is being monitored by a second person, the second person, at any time, may request authorization from the first person to increase the second person's access level to the first person's credit (as described with reference to FIG. 12). The second person may also, at any time, stop monitoring the first person's credit or may reduce the second person's access level to the first person's credit (as described with reference to FIG. 13).

FIG. 12 is a flowchart illustrating an example process for a person to request an increase in the access level of the person to another person's credit, according to various aspects of the present disclosure. The process 1200, in some of the present embodiments, may be performed by a processing unit of a client device, such as the client devices of FIGS. 1A-6, 7B, 8B, and 16. In other embodiments, the process 1000 may be performed by a processing unit of a server 1601-1602 of FIG. 16.

With reference to FIG. 12, a request may be received (at block 1205) from a second person who is monitoring a subset of a first person's credit report to make an increase in the subset of the first person's credit report being monitored by the second person. For example, the credit sharing network 111 may receive a request from the person 192 to get authorization for more access to the credit of the person 174, as described above with reference to stage 302 of FIG. 3A.

Next, an electronic message may be sent (at block 1210) to the first person requesting authorization to increase the second person's level of access to the first person's credit. For example, the credit sharing network 111 may send an electronic message to the person 174 requesting authorization for providing more access for the person 192 access to the credit of the person 174, as described above with reference to stages 302-303 of FIG. 3A.

Next, a determination may be made (at block 1215) whether a change to the access level is received from the first person. For example, the credit sharing network 111 may receive a change to the access level from the person 174 to increase. to decrease, or to cancel the access level of the person 192, as described above with reference to stages 306-309 of FIGS. 3B-3C.

When a change to the access level is received (at block 1215) from the first person, the level of access authorized by the first person may be identified (at block 1220). For example, the credit sharing network 111 may determine that the person 174 has selected any of the access levels 371-373 or the option 362 to cancel access, as described above with reference to stages 306-309 of FIGS. 3B-3C.

The second person may then be provided (at block 1225) the access level to the first person's credit as selected by the first person. For example, the person 192 may be provided the profile access to the credit of the person 174, as described above with reference to stage 311 of FIG. 3D. The process 1200 may then end.

When authorization is not received (at block 1215) from the first person, a determination may be made (at block 1230) whether the request to increase the access level is denied by the first person. For example, a determination may be made whether the person 174 has selected the option 361 (stage 306 of FIG. 3B) to deny the increase in the access level, as described above with reference to stage 306 of FIG. 3B. When the request to increase the access is not denied (at block 1230) by the first person, the processing may proceed to block 1215, which was described above. Otherwise, the second person may be notified (at block 1235) that the authorization to increase the access level to the first person's credit is denied by the first person. The process 1200 may then end.

In some of the present embodiments, when the credit of a first person is being monitored by a second person, the second person, at any time, may stop the monitoring or may reduce the level of the monitoring of the first person's credit. FIG. 13 is a flowchart illustrating an example process 1300 for a person to stop the monitoring of another person's credit or to reduce the level of the monitoring of the other person's credit, according to various aspects of the present disclosure.

The process 1300, in some of the present embodiments, may be performed by a processing unit of a client device, such as the client devices of FIGS. 1A-6, 7B, 8B, and 16. In other embodiments, the process 1300 may be performed by a processing unit of a server 1601-1602 of FIG. 16.

With reference to FIG. 13, a determination may be made (at block 1305) whether a request is received from a second person to cancel monitoring of a first person's credit. For example, the credit sharing network 111 may receive a request from the person 112 to stop monitoring the credit of the person 126, as described above with reference to stage 602 of FIG. 6.

When a request is received (at block 1305) from the second person to cancel monitor of the first person's credit, the authorization of the second person to monitor the credit of the first person may be canceled (at block 1310). The processing may then proceed to the block 1315, which is described below.

When a request is not received (at block 1305) from the second person to cancel monitor of the first person's credit, a determination may be made (at block 1320) whether a request is received from the second person to reduce the level of monitoring of the first person's credit by the second person. If not, the process 1300 may end. Otherwise, The level of monitoring of the first person's credit by the second person may be reduced (at block 1325) as requested by the second person.

Next, the first person may be notified (at block 1315) of the change in the level of monitoring of the first person's credit by the second person. For example, the first person may receive a message from the credit sharing network 111 indicating that the second person is no longer monitoring the first person's credit, or the second person has reduced the level of monitoring. The process 1300 may then end.

In some of the present embodiments, the credit sharing network may combine the credit reports of two or more persons. Combining the credit reports of multiple persons may require authorization from all persons whose credit reports are being combined. Combining the credit report of a group of persons, in some scenarios, may result in a combined credit score that is higher or lower than the credit report of some or all individual persons in the group.

Once the combined credit report is available, the credit sharing network may provide financial advice and/or may suggest financial products to the persons in the group based on the combined report. The persons in the group may request that their combined credit report to be forwarded to one or more entities such as, for example, and without limitations, financial institutions, loan brokers, landlords, investors, etc.

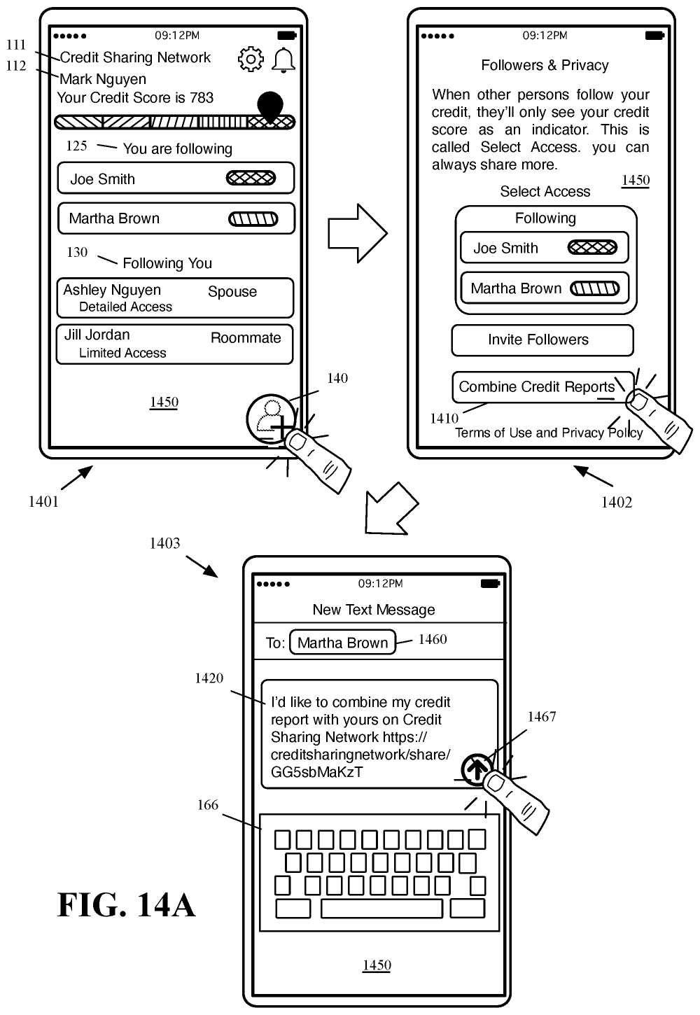

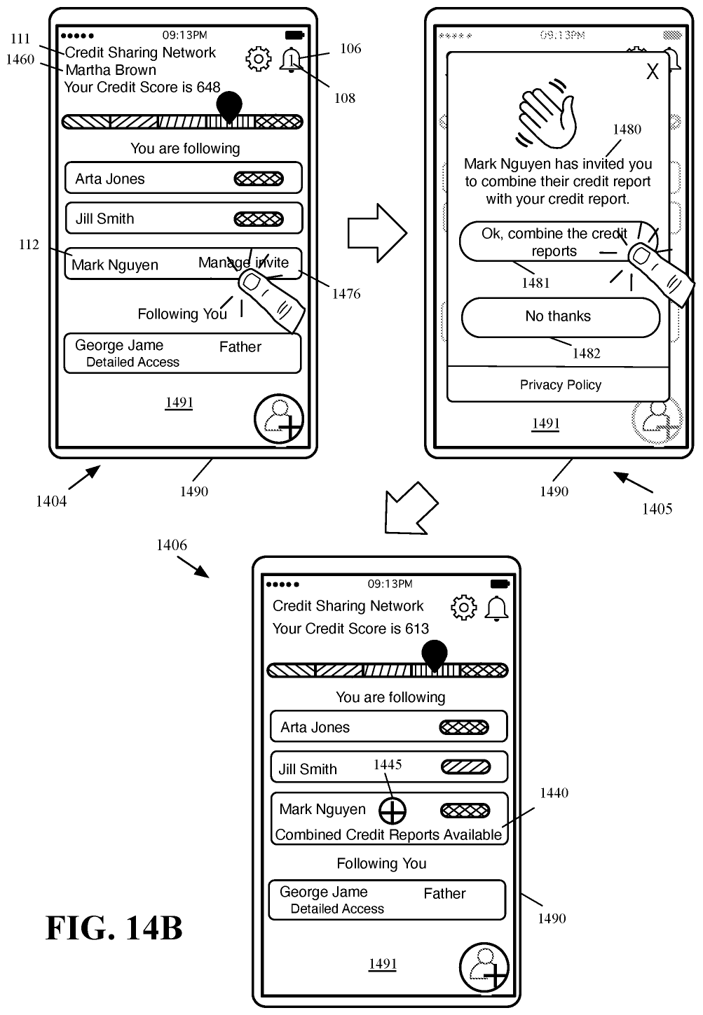

FIGS. 14A-14B illustrate schematic front view of client devices that may include a credit sharing application program which may provide an option for combining the credit reports of two more persons, according to various aspects of the present disclosure. FIGS. 14A-14B, as shown, include six operational stages. In stage 1401, the credit sharing application program of the credit sharing network 111 may display a UI 1450. The UI 1450 may display the name of the credit sharing network 111 and the name 112 of the person whose credit report is displayed by the UI 1450.

The UI 1450, in stage 1401, may display a list 125 of the persons whose credit report is monitored by the person 112 and a list 130 of the persons who are monitoring the credit of the person 112. The UI 1450 may provide an edit tool 140 to add persons to monitor the credit report of the person 112, to add persons to follow their credit report by the person 112, and/or to combine the credit report of the person 112 with the credit report(s) of one or more other persons that are also registered with the credit sharing network 111. As shown in stage 1401, the edit tool 140 may be selected.

In response to the selection of the tool 140, the UI 1450, in stage 1402, may display an option 1410 for combining credit reports. The UI 1450, in stage 1402, may receive the selection of the option 1410. In response, the UI 1450, in stage 1403, may receive the name(s) 1460 of one or more persons (e.g., through a touch keyboard 166 and/or a physical keyboard) and a message 1420 may be composed to send to the invited person(s) to combine their credit reports with the credit report of the person 112. In the example of FIG. 14A the composed text message 1420 may be sent to the recipient(s) after the selection of the option 1467.

FIG. 14B shows the client device 1490 of the person 1460. As shown in stage 1404, the UI 1491 may be displayed. The indicator 106, in stage 1404, may be badged with the number 108 of actions that may be pending for the person 1460. The UI 1491 may display the name 112 of the person who has requested an action from the person 1460 and an indicator 1476 showing that an invitation needs to be managed. As shown, the indicator 1476 (or the name 112) may be selected in stage 1404.

In response, the UI 1491 may display a message 1480 in stage 1405 indicating that the person 112 has invited the person 1460 to combine their credit reports. The UI 1491 may display an option 1481 to approve the invitation and an option 1482 to reject the invitation. As shown, the option 1481 may be selected in stage 1405 to approve the invitation. In response to the selection of the option 1481, the UI 1491 in stage 1406 may combine the credit reports of the persons 112 and 1360. The UI 1491 may provide a text 1440 and/or an indicator 1445 showing that the credit report of the person 112 is combined with the credit report of the person 1460.

Combining the credit reports of multiple persons, in some embodiments, may include calculating a weighted score from the combination of the credit score of each person. The weight given to the credit score of each person may include, for example, and without limitations, the current value of their credit score of the person, the cash flow generated by the person, the cash at hand of the person, the stocks and bonds owned by the person, etc. In some of the present embodiments, the credit sharing network may request each person to provide information regarding their cash flow, the cash at hand, the stocks and bonds owned, etc., and may verify the information in order to provide weight for different factors in a weighted sum calculation.

When the combined credit report is generated for acquiring a particular loan, to pay off one or more loans, etc., the combined credit score may also be affected by the amount of debts and obligations that may be removed after acquiring the particular loan or paying off the particular debts. The combined credit report, in some embodiments, may include the combined credit score as well as the full credit reports of each individual person whose credit is combined. The combined credit report, in some embodiments, may include the combined credit score as well as a subset of the credit reports of each individual person whose credit is combined.

The combined credit report may be stored. The credit sharing network 111 may make recommendations for paying off debts and/or may make recommendations for financial products to the persons based on their combined credit reports. The combined credit report may be forwarded to one or more entities such as financial institutions, creditors, landlords, etc., based on requests from the persons whose credit reports are combined.

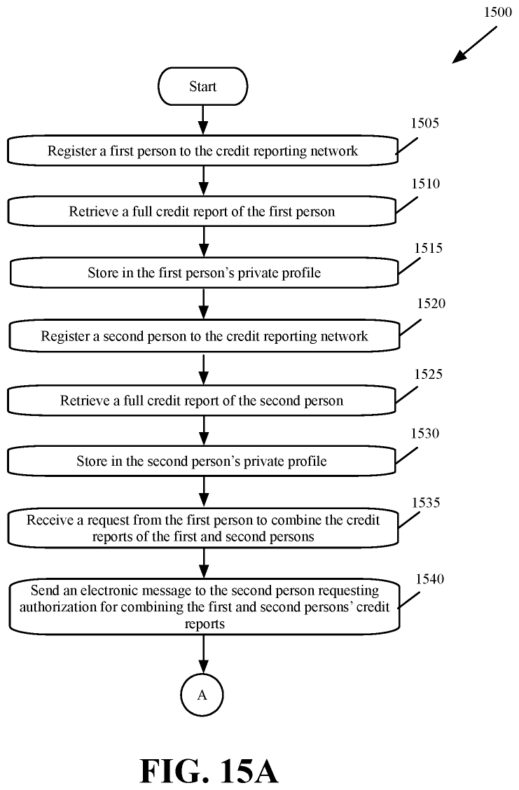

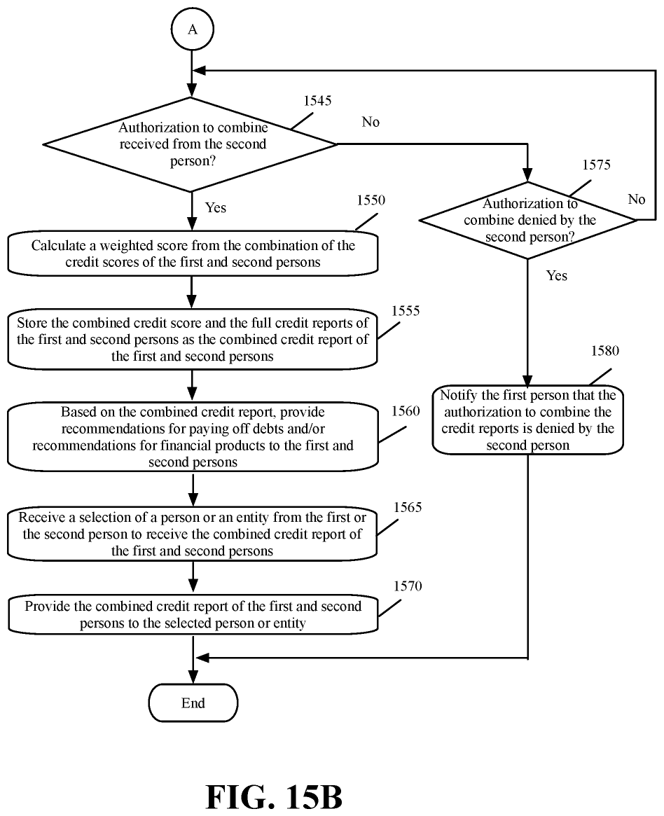

FIGS. 15A-15B are a flowchart illustrating an example process 1500 for combining the credit reports of two or more persons, according to various aspects of the present disclosure. The process 1500, in some of the present embodiments, may be performed by a processing unit of a client device, such as the client devices of FIGS. 14A-14B and 16. In other embodiments, the process 1500 may be performed by a processing unit of a server 1601-1602 of FIG. 16.

With reference to FIGS. 15A-15B, the process 1500 may register (at block 1505) a first person to a credit sharing network. For example, a person 112 may be registered to the credit sharing network 111 of FIG. 14A. Next, a full credit report of the first person may be retrieved (at block 1510). For example, the credit sharing network 111 may retrieve the full credit report of the person 112 from one of the credit reporting bureaus. In some embodiments, retrieving the credit report of the person may be done without a hard pull, which may not result in a hard inquiry listing in the person's credit report.

The first person's full credit report may be stored (at block 1515) in the first person's private profile. In some embodiments, the credit sharing network may create a private profile for each registered member and may store the full credit report of the person in the person's private profile. The full credit report of a person or any portions thereof may not be shared with any other members of the credit sharing network without the consent of the person.

The process 1500 may register (at block 1520) a second person to the credit sharing network. For example, a person 1460 may be registered to the credit sharing network 111 of FIG. 14A. Next, a full credit report of the second person may be retrieved (at block 1525). For example, the credit sharing network 111 may retrieve the full credit report of the person 1460 from one of the credit reporting bureaus.

The second person's full credit report may be stored (at block 1530) in the second person's private profile. A request may be received (at block 1535) from the first person to combine the credit reports of the first and second persons. For example, the credit sharing network 111 may receive a selection of the option 1410 and the option 1467 from the person 112, as described with reference to stages 1402-1403 of FIG. 14A.

Next, an electronic message may be sent (at block 1540) to the second person requesting authorization for combining the first and second persons' credit reports. For example, the credit sharing network 111 may send an electronic message to the person 1460 after the option 1467 is selected, as described above with reference to stage 1403 of FIG. 14A.

A determination may be made (at block 1545) whether authorization to combine is received from the second person. For example, a determination may be made whether the option 1481 is selected in stage 1405 of FIG. 14B. When an authorization is not received from the second person, the processing may proceed to block 1575, which is described below. Otherwise, a weighted score from the combination of the credit scores of the first and second persons may be calculated (at block 1550). For example, a weighted score from the credit scores of the first and second persons may be calculated as described above with reference to stage 1406 of FIG. 14B.

The combined credit scores and the full credit reports of the first and second persons may be stored (at block 1555) as the combined credit report of the first and second persons. Based on the combined credit report, recommendations may be provided (at block 1560) for paying off debts and/or recommendations may be made (at block 1560) for financial products to the first and second persons.

At block 1565, a selection of a person or an entity may be received from the first or the second person to receive the combined credit report of the first and second persons. The combined credit report of the first and second persons may be provided (at block 1570) to the selected person or entity. The process 1500 may then end.

When authorization is not received (at block 1545) from the second person, a determination may be made (at block 1575) whether the authorization to combine the credit reports is denied by the second person. For example, a determination may be made whether the option 1482 is selected by the person 1460 in stage 1405 of FIG. 14B. If not, the processing made proceed back to block 1545, which was described above. Otherwise, when the authorization to combine the credit reports is denied by the second person, the first person may be notified (at block 1580) that the authorization to combine the credit reports is denied by the second person. The process 1500 may then end. Although the process 1500 was described with reference to combining the credit reports of two persons, it should be noted that the same process may be used to combine the credit reports of more than two persons.

FIG. 16 is a functional block diagram illustrating an example system for sharing credit information, according to various aspects of the present disclosure. With reference to FIG. 16, the secured credit sharing network 111 may include one or more servers 1601-1602 and one or more databases 1611-1615. The credit sharing network 111 may communicate with one or more credit reporting bureau servers 1621-1622, one or more financial institute servers 1631-1632, and one or more client services 1641-1642 through one or more networks 1650. Access to the secured credit sharing network 111 may be provided through one or more levels of authentication. The communication links between different devices and databases shown in FIG. 16 may be encrypted.

With further reference to FIG. 16, the servers 1601-1602 may include, for example, and without limitations, web servers, database servers, and/or application servers, etc. The databases 1611-1615 may include, for example, and without limitations, databases for storing credit reports 1611, user profiles 1612, financial institutions profiles 1613, credit reporting bureaus profiles 1514, and/or other databases 1615.

The network(s) 1650 may include user's network (e.g., Wi-Fi, Ethernet), the Internet, telecommunication networks (e.g., public switched telephone network (PSTN), packet-switched network), and/or networks of servers/backend devices. The credit reporting bureaus servers 1621-1622 may be the servers of one or more credit reporting bureaus that are used by the credit sharing network 111 to retrieve the credit profiles of the persons who register with the credit sharing network 111.

The financial institute servers 1631-1632 may be the servers used by one or more financial institutions, such as for example, and without limitations, banks, savings and loan companies, loan brokers, etc., that may use the credit sharing network 111 to offer financial services to the persons registered to the credit sharing network 111. The financial institute may also be used by the persons registered to the credit sharing network 111 for applying for loans, for applying for lines of credit, for sending combined credit reports, etc.

The client devices 1641-1642 may be client devices, such as, the client devices described above with reference to FIGS. 1A-6, 7B, 8B, 16, and/or 14A-14B. The client devices 1641-1642 may be used by persons registered with the credit sharing network 111 in order to use the services of the credit sharing network 111, as described in the embodiments of the present invention described above. The client devices 1641-1642 may comprise, for example, mobile devices such as a smartphone or personal digital assistant (PDA), computing device such as tablet computers, a laptop computers, desktop computers, etc.

Many of the above-described features and applications may be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions may be implemented as sub-parts of a larger program while remaining distinct software inventions. In some embodiments, multiple software inventions may also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

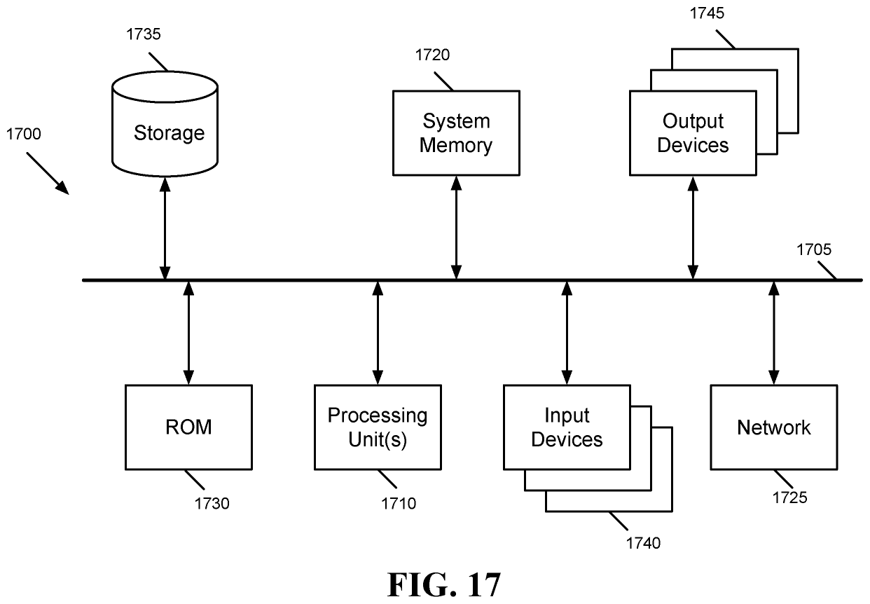

FIG. 17 is a functional block diagram illustrating an example electronic system 1700, according to various aspects of the present disclosure. With reference to FIG. 17, some embodiments of the invention, such as for example, and without limitations, the servers and the client devices described above, may be implemented using the electronic system 1700. The electronic system 1700 may be used to execute any of the processes, methods, controls, or operating system applications described above. The electronic system 1700 may be a computer (e.g., a desktop computer, personal computer, tablet computer, server computer, mainframe, a blade computer etc.), a phone (e.g., a smartphone), a personal digital assistant (PDA), or any other sort of electronic device. Such an electronic system may include various types of computer readable media and interfaces for various other types of computer readable media. The electronic system 1700 may include a bus 1705, processing unit(s) 1710, a system memory 1720, a read-only memory (ROM) 1730, a permanent storage device 1735, input devices 1740, and output devices 1745.

The bus 1705 may collectively represent all system, peripheral, and chipset buses that communicatively connect the numerous internal devices of the electronic system 1700. For example, the bus 1705 may communicatively connect the processing unit(s) 1710 with the read-only memory 1730, the system memory 1720, and the permanent storage device 1735.

From these various memory units, the processing unit(s) 1710 may retrieve instructions to execute and data to process in order to execute the processes of the invention. The processing unit(s) may be a single processor or a multi-core processor in different embodiments.

The read-only-memory 1730 may store static data and instructions that are needed by the processing unit(s) 1710 and other modules of the electronic system. The permanent storage device 1735, on the other hand, may be a read-and-write memory device. This device is a non-volatile memory unit that may store instructions and data even when the electronic system 1700 is off. Some embodiments of the invention may use a mass-storage device (such as a magnetic or optical disk and its corresponding disk drive) as the permanent storage device 1735.

Other embodiments may use a removable storage device (such as a floppy disk, flash drive, etc.) as the permanent storage device. Like the permanent storage device 1735, the system memory 1720 may be a read-and-write memory device. However, unlike storage device 1735, the system memory may be a volatile read-and-write memory, such as random access memory. The system memory may store some of the instructions and data that the processor needs at runtime. In some embodiments, the invention's processes may be stored in the system memory 1720, the permanent storage device 1735, and/or the read-only memory 1730. From these various memory units, the processing unit(s) 1710 may retrieve instructions to execute and data to process in order to execute the processes of some embodiments.

The bus 1705 may also connect to the input and output devices 1740 and 1745. The input devices may enable the user to communicate information and select commands to the electronic system. The input devices 1740 may include alphanumeric keyboards and pointing devices (also called “cursor control devices”). The output devices 1745 may display images generated by the electronic system. The output devices may include printers and display devices, such as cathode ray tubes (CRT) or liquid crystal displays (LCD). Some embodiments may include devices such as a touchscreen that function as both input and output devices.

Finally, as shown in FIG. 17, the bus 1705 may also couple the electronic system 1700 to a network 1725 through a network adapter (not shown). In this manner, the computer may be a part of a network of computers (such as a local area network (“LAN”), a wide area network (“WAN”), an Intranet, or a network of networks, such as the Internet. Any or all components of the electronic system 1700 may be used in conjunction with the invention.

Some embodiments may include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments may be performed by one or more integrated circuits, such as application specific integrated circuits (ASICs) or field programmable gate arrays (FPGAs). In some embodiments, such integrated circuits may execute instructions that are stored on the circuit itself. Some of the present embodiments may include flexible circuit, also rereferred to as flexible printed circuit boards (PCBs). The flexible circuits may provide dynamic flexing and increased heat dissipation and may be used in the embodiments that require circuits with smaller footprint, increased package density, more tolerance to vibrations, and/or less weight.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A method of monitoring credit report, the method comprising:
by a computer of a social network:
registering first and second persons to the social network;
receiving, from an electronic device associated with the first person, a request to allow the second person to monitor a subset of the first person's credit report;
receiving, from the electronic device associated with the first person, an identification of the subset of the credit report to be shared, the subset of the credit report of the first person being less than a full credit report of the first person;
sending an electronic message to an electronic device associated with the second person requesting an authorization to provide the second person access to the subset of the first person's credit report;
receiving an authorization from the second person to provide access to the second person to the subset of the first person's credit report; and
providing the second person access to said subset of the first person's credit report after receiving the authorization from the second person.

2. The method of claim 1, wherein the subset of the first person's credit report is a first subset of the first person's credit report, the method further comprising:
by the computer of the social network:
receiving a request from the second person to monitor a second subset of the first person's credit report, the second subset comprising additional information from the first person's credit report; and
sending an electronic message to the first person requesting an authorization for providing access to the second person to the second subset of the first person's credit report.

3. The method of claim 2 further comprising:
by the computer of the social network:
receiving, from the first person, the authorization for providing access to the second person to the second subset of the first person's credit report; and
providing access to the second subset of the first person's credit report after receiving the authorization from the second person.

4. The method of claim 2 further comprising:
by the computer of the social network:
receiving, from the first person, a denial for providing the second person access to the second subset of the first person's credit report; and
denying access to the second subset of the first person's credit report to the second person.

5. The method claim 2, wherein the second subset of the first person's credit report comprises a full credit report of the first person.

6. The method of claim 1, wherein the subset of the first person's credit report comprises an indicator indicating a credit worthiness of the first person.

7. The method of claim 6, wherein the indicator is one of an emoji and a color code.

8. The method of claim 1, wherein the subset of the first person's credit report comprises a credit score of the first person.

9. The method of claim 1, wherein the subset of the first person's credit report comprises a set of one or more tradelines, each tradeline comprising information regarding an amount of a loan and an identification of a creditor of the loan.

10. The method of claim 9, wherein the tradeline further comprises one or more of the creditor's name and address, a type of the loan, at least a subset of an account number associated with the loan, a current status of the loan, a date the loan was granted, a date, a date of a last activity on the loan, an original amount of the loan, a monthly payment required for the loan, and a payment history for the loan.

11. The method of claim 1 further comprising:
by the computer of the social network:
receiving, from the first person, a request to revoke the authorization for providing access to the second person to the subset of the first person's credit report; and
denying access by the second person to the subset of the first person's credit report after receiving the request to revoke the authorization from the first person.

12. The method of claim 1, wherein the subset of the first person's credit report is a first subset of the first person's credit report, the method further comprising:
by the computer of the social network:
receiving, from the first person, a request to reduce a level of reporting the first person's credit to the second person from the first subset of the first person's credit report to a second subset of the first person's credit report, the second subset comprising less information that the first subset; and
only providing access to the second subset of the first person's credit report to the second person after receiving the request to reduce the level of reporting from the first person.

13. The method of claim 1 further comprising, by the computer of the social network, providing the second person with a periodic update to the subset of the first person's credit report.

14. The method of claim 1 further comprising:
providing to the first person, a list of persons that are monitoring the credit of the first person and a list of persons whose credits are being monitored by the first person; and
providing to the second person, a list of persons that are monitoring the credit of the second person and a list of persons whose credits are being monitored by the second person.

15. The method of claim 1 further comprising:
receiving kudos from the electronic device associated with the second person regarding the credit worthiness of the first person; and
sending the kudos to the electronic device associated with the first person.

16. A method of combining credit reports of a plurality of persons, the method comprising:
by a computer of a credit reporting network:
registering first and second persons to a credit reporting network;
storing a credit report of the first person in a credit reporting network's profile of the first person, the credit report of the first person comprising a credit score of the first person;
storing a credit report of the second person in a credit reporting network's profile of the second person, the credit report of the second person comprising a credit score of the second person;
receiving a request from each of the first and second persons to provide a combined credit report of the first and second person to a third party entity as a pre-qualification for acquiring a loan;
retrieving the credit score of the first person from the profile of the first person;
retrieving the credit score of the second person from the profile of the second person;
calculating a weighted sum of the credit scores of the first and second person, the weighted sum comprising providing a first weight to the credit score of the first person and a second weight to the credit score of the second person; and
providing a combined credit report of the first and second persons to an electronic device associated with the third party entity, the combined credit report comprising the weighted sum of the credit scores.

17. The method of claim 16, wherein the first weight is determined based on the credit score of the first person and a cashflow generated by the first person, and wherein the second weight is determined based on the credit score of the second person and a cashflow generated by the second person.

18. The method of claim 17, wherein the weighted sum of the credit scores of the first and second person is greater than the credit scores of the first and second persons.

19. The method of claim 16, wherein calculating the weighted sum of the credit scores comprises averaging the credit scores of the first and second person.

20. The method of claim 16, wherein the combined credit report further comprises a full credit report of the first person and full credit report of the second person.

21. The method of claim 16, wherein the first and second persons are partners in a business acquiring the loan for the business, the method further comprising sending a request, from the computer of the credit reporting network the electronic device associated with the third party, for the loan for the business on behalf of the first and second persons.

22. The method of claim 16, wherein the first and second persons are spouses acquiring the loan for purchasing a property, the method further comprising sending a request, from the computer of the credit reporting network the electronic device associated with the third party, for the loan for purchasing the property on behalf of the first and second persons.
